(19) United States
(12) Patent Application Publication
(10) Pub. No.: US 2013/0214193 A1
(43) Pub. Date: Aug. 22, 2013

(54) BIODEGRADABLE FIRE SUPPRESSING COMPOSITION WITH HYDROCARBON DISPERSENT

(71) Applicants: James Alroy E. Hagquist, St. Paul, MN (US); Terrance L. Lund, Woodbury, MN (US); Roderick I. Lund, Woodbury, MN (US)

(72) Inventors: James Alroy E. Hagquist, St. Paul, MN (US); Robert M. Hume, III, Woodbury, MN (US); Terrance L. Lund, Woodbury, MN (US); Roderick I. Lund, Woodbury, MN (US)

(73) Assignee: EARTHCLEAN CORPORATION, South St. Paul, MN (US)

(21) Appl. No.: 13/809,636

(22) PCT Filed: Jul. 11, 2011
(86) PCT No.: PCT/US11/43546

§ 371 Date: Mar. 4, 2013

Related U.S. Application Data
(60) Provisional application No. 61/364,203, filed on Jul. 14, 2010.

(51) Int. Cl. A62D 1/00

(52) U.S. Cl. CPC A62D 1/0007
USPC 252/2

(57) ABSTRACT

A fire suppressing solution includes an intumescent char forming material and a hydrocarbon dispersion material. The intumescent char forming material includes a starch, a pseudo-plastic, high yield, suspending agent, and a neutralizer.

### BACKGROUND

Fire is a continuing danger to life and property worldwide. In rural areas forest, brush, and grassland fires cause immense damage each year. This destruction is not only in terms of the dollar value of timber, wildlife and livestock, but the catastrophic effects on erosion, watershed equilibrium and related problems to the natural environment. In urban areas, fire and the damage from large quantities of water used to extinguish a fire is responsible for the destruction of buildings with the loss of billions of dollars annually. Most importantly, fire is a major danger to human life.

Over the years man has found numerous methods for combating fires. The use of water, chemicals and other extinguishing materials are well documented. Water treated with a wetting agent has been proven to be more effective on a Class A fire where good water penetration is needed to reach and extinguish the seat of the fire. Currently, there have been efforts in the area of pretreatment with chemical retardants or suppressants. A number of these pretreatments have been developed and used for fighting rural forest fires. For example, antimony oxide and its complexes, borates, carbonates, bicarbonates, ammonium phosphate, ammonium sulfates, and other salts capable of being hydrated, have been demonstrated to have useful properties as firefighting chemicals. However, although the fire inhibiting properties of the borates, carbonates and bicarbonates have been established, the use of these materials for vegetation fires has been limited because of their tendency to inhibit plant growth when used in large quantities.

Another method of fighting fires is the pretreatment of flame-retardant materials on combustible surfaces that lead to the creation of intumescent coating materials. Intumescent materials expand with heat, similar to a vermiculite which expands when exposed to steam. The expanded layer then protects the original surface from heat and flame. The problem is that an expanded intumescent is also very fragile. This problem was soon realized, and the intumescent needed a protective hard outer coating. This lead to methods using carbonaceous materials to form a char instead of the materials being consumed by the fire.

In addition to all these problems, the most difficult problem to overcome for chemical retardant formulations is that they are relatively expensive, compared to water. Also of concern is the environmental impact of absorbent particles presently used in various gel formulations. The absorbent particles pose an environmental risk once used to fight a fire, particularly when used on a large scale, such as a forest fire. The cost factor also comes into conflict with applying them in large quantities, as is often required. In combating or preventing forest, brush and grass range fires, a considerable amount of effort has been spent in the search for low cost or waste materials that are both available in quantity and inexpensive.

### BRIEF SUMMARY

The present disclosure relates to biodegradable fire suppressing compositions that include an oil or hydrocarbon dispersent. In particular the present disclosure relates to biodegradable fire suppressing solution that includes an intumescent char forming material and a hydrocarbon dispersion material.

In one illustrative embodiment, a fire suppressing solution includes an intumescent char forming material and a hydrocarbon dispersion material. The intumescent char forming material includes a starch, a pseudo-plastic, high yield, suspending agent, and a neutralizer.

In another illustrative embodiment, a fire suppressing solution includes an intumescent char forming material and a hydrocarbon dispersion material. The intumescent char forming material includes 35 to 75 parts starch, 25 to 60 parts pseudo-plastic, high yield, suspending agent, 0.5 to 20 parts neutralizer. The hydrocarbon dispersion material includes 4 to 40 parts ethoxylated tertiary amine, 1 to 15 parts aliphatic carboxylic acid, and 1 to 6 parts aliphatic alcohol.

In a further illustrative embodiment, a fire suppressing solution includes an intumescent char forming material, a hydrocarbon dispersion material and water. The intumescent char forming material includes starch, pseudo-plastic, high yield, suspending agent, and a neutralizer. The hydrocarbon dispersion material includes an ethoxylated tertiary amine, an aliphatic carboxylic acid, and an aliphatic alcohol. The fire suppressing solution has a pH in the range of 5.0 to 8.0. The fire suppressing solution clings to a surface positioned in any orientation and forms an exterior intumescent char coating upon fire contact, while retaining an interior aqueous gel composition.

In another illustrative embodiment, a method of forming a fire suppressing solution includes mixing an intumescent char forming material comprising starch, pseudo-plastic, high yield, suspending agent, and neutralizer, with a hydrocarbon dispersion material to form a fire suppressing solution.

These and various other features and advantages will be apparent from a reading of the following detailed description.

### DETAILED DESCRIPTION

In the following description, it is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The present disclosure relates to biodegradable fire suppressing solution. In particular the present disclosure relates to biodegradable fire suppressing solution that can utilized directly to retard or suppress fire or can be diluted with water (to form a fire suppressing dilute solution) and directed onto a substrate to retard or suppress fire. The biodegradable fire suppressing solution (or fire suppressing dilute solution) includes an intumescent char forming material and a hydrocarbon dispersion material. The terms “solution” and “dilute solution” are utilized interchangeably herein. The intumescent char forming material includes a starch, a pseudo-plastic, high yield, suspending agent, and a neutralizer. The hydrocarbon dispersion material includes an ethoxylated tertiary amine, an aliphatic carboxylic acid, and an aliphatic alcohol. The biodegradable fire suppressing liquid can be diluted with water to form a fire suppressing dilute solution that has been found to be useful in suppressing both Class A and Class B fires. The resulting fire suppressing solution or dilute solution can form a crust after making contact with a heat source. After crusting-over occurs, continued heating or burning near the product causes the crust to turn to a carbonized char. At this point, the product consists of an outer coat of char, which forms an intumescent coating, and an interior of a gelled aqueous composition. This synergist combination of outer coat of char protecting an interior gel, remains in place until the solution's water has been evaporated. The diluted product functions as a heat sink, maintaining a substrate temperature below a certain temperature (e.g., 100 degrees centigrade for example). While the present disclosure is not so limited, an appreciation of various aspects of the disclosure will be gained through a discussion of the examples provided below.

The disclosed biodegradable fire suppressing solution can be augmented with water and used to extinguish fires, for example. In some embodiments, either the intumescent char forming material or the hydrocarbon dispersion material can be diluted with water and then the other component added to form the fire suppression solution or dilute solution. The biodegradable fire suppressing solution or each component of the fire suppressing solution can be added to a water reservoir or injected directly into a liquid stream that may be directed to a substrate for fire suppression or fire retarding.

The fire suppressing solution is pumped or sprayed by typical high pressure pumping equipment or by low-pressure individual back tanks. The fire suppressing solution or dilute solution has a “high yield value,” meaning it has an initial resistance to flow under stress but then is shear thinning, and when used, exhibits “vertical cling,” meaning it has the ability at rest, to immediately return to a thixotropic gel. The solution that does not separate or settle, can be easily sprayed and immediately thickens when it contacts a wall or ceiling surface. This gives the firefighter, for example, the ability, unlike water alone, to form thickness and hold the fire suppressing solution on vertical or overhead surfaces. The fire suppressing solution's mass and the vertical cling both acts as a heat sink capable of clinging to vertical and overhead surfaces. This clinging to the surfaces causes the overall temperature of the surfaces to remain below the boiling point of water. The heat sink effect does not allow the temperature of the surface coated with the fire suppressing solution of the composition to rise above a certain temperature (e.g., 100 degrees centigrade for example), until the water in the composition has been evaporated. To produce this shear thinning effect and then cling, the composition uses a pseudo-plastic high yield-suspending agent.

In many embodiments the fire suppressing solution includes an intumescent char forming material and a hydrocarbon dispersion material. The term “material” denotes either a concentrate (powder or liquid) or a diluted concentrate (i.e., solution). The intumescent char forming material includes a starch, a pseudo-plastic, high yield, suspending agent, and a neutralizer. The hydrocarbon dispersion material includes an ethoxylated tertiary amine, an aliphatic carboxylic acid, and an aliphatic alcohol. These materials can be mixed or blended utilizing a mixer to obtain a liquid concentrate composition or added sequentially to a dilution system prior to being applied to a target surface for fire suppression. For example the intumescent char forming material can be added to a volume of water for form an intermediate solution and then the hydrocarbon dispersion material can be added to the intermediate solution to form the fire suppressing solution or dilute solution. It has been found that these compositions quickly form a stable suspension or solution when combined with water. In many embodiments, the diluted fire suppressing solution or dilute solution has a pH in the range of 5.0 to 8.0 and the fire suppressing solution or dilute solution clings to a surface positioned in any orientation, and forms an exterior intumescent char coating upon fire contact, while retaining an interior aqueous gel composition.

In many embodiments, the fire suppressing solution is formed by diluting the intumescent char forming material with water to form an intermediate solution. The intermediate solution can include from 0.1 to 5wt % intumescent char forming material or from 0.1 to 2% wt intumescent char forming material. The hydrocarbon dispersion material can then be added to the intermediate solution to form the fire suppressing solution or dilute solution. The fire suppressing solution or dilute solution can include from 0.1 to 10% wt hydrocarbon dispersion material or from 0.5 to 6% wt hydrocarbon dispersion material. Thus the fire suppressing liquid or dilute solution contains a ratio of intumescent char forming material and hydrocarbon dispersion material in a range from 1:0.5-5.

The hydrocarbon dispersion material can include an ethoxylated tertiary amine, an aliphatic carboxylic acid, and an aliphatic alcohol. In many embodiments, the hydrocarbon dispersion material includes an ethoxylated tertiary (C16-C18) amine having 2 to 10 ethoxy groups per mole, a (C6-C12) aliphatic carboxylic acid, and a (C7-C12) aliphatic alcohol. The hydrocarbon dispersion material can include 4 to 40 parts ethoxylated tertiary amine, 1 to 15 parts aliphatic carboxylic acid, and 1 to 6 parts aliphatic alcohol. Commercially available hydrocarbon dispersion material includes FireAde 2000™ and is available from Fire Service Plus, Inc., (Fayetteville, Ga.), for example. Illustrative hydrocarbon dispersion materials are described in U.S. Pat. No. 6,645,390 which is incorporated by reference herein. It has been found that the presence of the hydrocarbon dispersion material improves the performance of the fire suppressing solution.

When diluted with water or injected into a stream of water, the fire suppressing solution or dilute solution can make up from 0.1 to 10 wt % or from 0.5 to 5 wt % of the diluted water solution.

There are many types of pseudo-plastic high yield suspending agents or rheology modifiers that can be used successfully in the inventive composition. Two of the major groups of such suspending agents are laponites (that are generally synthetic smectite clay), and CARBOPOLS™ (that are generally high molecular weight homo- and copolymers of acrylic acid cross linked with a polyalkenyl polyether). Other polymers and synthetic clays are suitable and may be used in combination to develop special pseudo-plastic high yield suspending agent characteristics. In using a combination of these suspending agents, synergism is found, for example, between laponites and CARBOPOLS™, where a blend offers improved characteristics for the composition. Of the group of laponites, which are synthetic smectite clays closely resembling the natural clay mineral hectoritic, it was found that Laponites RD and RDS provide the best performance Laponites RD and RDS are layered hydrous magnesium silicates that disperse rapidly in water without the need for high shear. Laponites RD and RDS are manufactured by Southern Clay Products, Inc., Gonzales, Tex. 78629, and are commercially available from Fitz Chemical Corporation, Itasca, Ill. 60143.

In another major group of suspending agents, the CARBOPOLS™, one particularly effective material is CARBOPOLS™ EZ-3, a hydrophobically modified cross-linked polyacrylate powder. The polymer is self-wetting and can require low agitation for dispersion. The convenience of low agitation is very evident in the very short wetting out time needed, when making a concentrate. CARBOPOLS™ EZ-3 is commercially available from Noveon, Inc., Cleveland, Ohio 44141. These materials hold solid particles in suspension without allowing the solids to settle. These materials have a shear thinning rheology so they can be pumped or sprayed onto a surface without the loss of cling. The CARBOPOLS™ EZ-3 is the more efficient of pseudo-plastic high yield suspending agents tested and the Laponite RDS one of the fastest to build in viscosity, as tested after shear thinning The laponites are especially sensitive to electrolytes or the typical salts in water. Many pseudo-plastic high yield suspending agents need to be fully dispersed and hydrated in water to achieve the best performance characteristics. The suspension composition improves the overall efficiency of putting fire out with water. Other suitable pseudo-plastic, high yield, suspending agents include modified guar and xantham gums, casein, alginates, modified cellulose, including methyl cellulose, hydroxyethyl cellulose, hydroxypropyl cellulose and carbomethyl cellulose, gum tragacanth used individually or in combination.

The fire suppressing solutions described herein have a high yield value with a “shear thinning capacity” which means, the fire suppressing solutions or dilute solutions become thin (ie., lower viscosity) when pumped and instantly thixotropic or sag resistant, at rest. Thus, after being pumped and sprayed, the fire suppressing solutions or dilute solutions are capable of clinging to a vertical or overhead surface.

Any starch can be used in the fire suppressing solution or dilute solutions. Examples of starches include corn, wheat, potato, tapioca, barley, arrowroot, rice or any combination of starches. Dry starch contains about 12% water and has a particle size in a range from 1 to 50 micrometers. When soaked in water, the starch associates and holds up to 18% water and the particle size increases to 40 micrometers. As the starch/water mixture is heated, in this case by a fire, the starch forms a gel or association with all the surrounding water starting around 70 degrees centigrade. Thus, when the composition is heated, either from the substrate or the air side, the starch absorbs more water at the interface and becomes thicker. Although not wishing to be bound to any particular theory, it is believed that on the substrate side, the composition first rides on its own vapor and, as it cools, forms its own film on the substrate surface. On the air side, where evaporation largely occurs, the composition first thickens and then crusts over and eventually is converted to a carbonized char. The char formed is a hard, intumescent coating, which slows the evaporation of water from the composition. In essence, the composition's own film and char act as a vessel to contain the soft-gelled composition, which now acts as a heat sink to cool the backside of the intumescent char. This synergism between the intumescent hard coating and the composition's aqueous gel helps optimize a very limited amount of water. The char/gel coating further reduces the available combustible material to the fire.

Hydrophobic agglomerating material can be added to the composition. In many embodiments the hydrophobic agglomerating material includes liquid paraffins. Paraffin is the common name for alkane hydrocarbons with the general formula CₙH₂ₙ₊₂. Liquid paraffin generally have less than 20 carbon atoms. In many embodiments the paraffin has from 10 to 15 carbon atoms and is linear. Commercially available paraffins include BIO-BASE™ 300 (11 to 13 carbon atoms) or BIO-BASE™ 200 (15 to 18 carbon atoms), for example, and are available from Shrieve Chemical Products Company (Woodlands, Tex.), for example. It has been found that the presence of the hydrophobic agglomerating material (e.g., liquid paraffin) improves the performance of the use solution.

The compositions can include a neutralizer or basic material. In many embodiments the basic material is any material capable of increasing pH when added to an aqueous material. In many embodiments the basic material includes an amine (e.g., an alcohol amine) or a hydroxide (e.g., caustic soda). In some embodiments the basic material include an amino-methyl-propanol (e.g., 2-amino-2-methly-1-propanol). One commercially alcohol amine is AMP-95™ and is available from Angus Chemical Company, for example.

The resulting fire suppressing solution can be packaged for later use such as, combining it with an amount of water and directing the diluted product onto a surface to suppress or retard fire, as described above. The intumescent char forming material and a hydrocarbon dispersion material can be provided in the diluted product in an amount ranging from 0.5 to 10 wt %, for example.

On illustrative fire suppressing solution was formed by diluting the intumescent char forming material with water to form an intermediate solution having 0.7% wt intumescent char forming material. The intumescent char forming material included about 50-60% wt corn starch, 35-40% wt Carbopol EZ-3, 5 to 10 wt % caustic soda and optionally 1-2% wt BioBase 200 or 300. Then the hydrocarbon dispersion material was added to the intermediate solution to form the fire suppressing solution having from 0.5 to 6 wt % hydrocarbon dispersion material. The hydrocarbon dispersion material was FireAde 2000, described above. This fire suppressing solution was capable of extinguishing or suppressing both Class A and Class B fires.

Thus, embodiments of the BIODEGRADABLE FIRE SUPPRESSING COMPOSITION WITH HYDROCARBON DISPERSENT are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present invention is limited only by the claims that follow.

1. A fire suppressing solution comprising;
an intumescent char forming material comprising:
a starch;
a pseudo-plastic, high yield, suspending agent; and
a neutralizer; and
a hydrocarbon dispersion material.

2. A fire suppressing solution according to claim 1 wherein the hydrocarbon dispersion material comprises an ethoxylated tertiary amine, an aliphatic carboxylic acid, and an aliphatic alcohol.

3. A fire suppressing solution according to claim 1 wherein the hydrocarbon dispersion material comprises an ethoxylated tertiary (C₁₆-C₁₈) amine having 2 to 10 ethoxy groups per mole, an (C₆-C₁₂)aliphatic carboxylic acid, and a (C₇-C₁₂)aliphatic alcohol.

4. A fire suppressing solution according to claim 1 wherein the solution forms a dilute solution when added to water; the dilute solution having a pH in the range of 5.0 to 8.0; whereby the dilute solution clings to a surface positioned in any orientation, and forms an exterior intumescent char coating upon fire contact, while retaining an interior aqueous gel composition.

5. A fire suppressing solution according to claim 1 wherein the neutralizer is a basic material comprising an amine and the pseudo-plastic, high yield, suspending agent comprises a mixture of an acrylic acid copolymer cross linked with a polyalkenyl polyether and a synthetic smectite clay.

6. A fire suppressing solution according to claim 1 wherein the neutralizer comprises an alcohol amine.

7. A fire suppressing solution according to claim 1 wherein the fire suppressing liquid contains a ratio of intumescent char forming material and hydrocarbon dispersion material in a range from 1:0.5-5.

8. A fire suppressing solution comprising;
an intumescent char forming material comprising:
35 to 75 parts starch;
25 to 60 parts pseudo-plastic, high yield, suspending agent; and
0.5 to 20 parts neutralizer; and
a hydrocarbon dispersion material comprising:
4 to 40 parts ethoxylated tertiary amine;
1 to 15 parts aliphatic carboxylic acid; and
1 to 6 parts aliphatic alcohol.

9. A fire suppressing solution according to claim 8 wherein the fire suppressing liquid contains a ratio of intumescent char forming material and hydrocarbon dispersion material in a range from 1:0.5-5.

10. A fire suppressing solution according to claim 8 wherein the solution forms a dilute solution when added to water; the dilute solution composition having a pH in the range of 5.0 to 8.0; whereby the dilute solution clings to a surface positioned in any orientation, and forms an exterior intumescent char coating upon fire contact, while retaining an interior aqueous gel composition.

11. A fire suppressing solution according to claim 8 wherein the pseudo-plastic, high yield, suspending agent comprises a mixture of an acrylic acid copolymer cross linked with a polyalkenyl polyether and a synthetic smectite clay.

12. A fire suppressing solution according to claim 8 wherein the hydrocarbon dispersion material comprises an ethoxylated tertiary (C₁₆-C₁₈) amine having 2 to 10 ethoxy groups per mole, an (C₆-C₁₂)aliphatic carboxylic acid, and a (C₇-C₁₂)aliphatic alcohol.

13. (canceled)

14. (canceled)

15. (canceled)

16. A method of forming a fire suppressing solution comprising:
mixing an intumescent char forming material comprising starch, pseudo-plastic, high yield, suspending agent, and neutralizer, with a hydrocarbon dispersion material to form a fire suppressing solution.

17. A method according to claim 16 further comprising the step of diluting the char forming material or hydrocarbon dispersion material or fire suppressing solution with water to form a fire suppressing dilute solution that clings to a surface positioned in any orientation, and forms an exterior intumescent char coating upon fire contact, while retaining an interior aqueous gel composition.

18. A method according to claim 17 further comprising directing the fire suppressing dilute solution toward a target.

19. A method according to claim 16 wherein the hydrocarbon dispersion material comprises an ethoxylated tertiary (C₁₆-C₁₈) amine having 2 to 10 ethoxy groups per mole, an (C₆-C₁₂)aliphatic carboxylic acid, and a (C₇-C₁₂)aliphatic alcohol.

20. A method according to claim 17 wherein the fire suppressing dilute solution comprises less than 10% wt intumescent char forming material and hydrocarbon dispersion material.

21. A method according to claim 17 wherein the fire suppressing solution comprises;
an intumescent char forming material comprising:
35 to 75 parts starch;
25 to 60 parts pseudo-plastic, high yield, suspending agent; and
0.5 to 20 parts neutralizer; and
an hydrocarbon dispersion material comprising:
4 to 40 parts ethoxylated tertiary amine;
1 to 15 parts aliphatic carboxylic acid; and
1 to 6 parts aliphatic alcohol.
